(19) United States
(12) Patent Application Publication
(10) Pub. No.: US 2008/0094424 A1
(43) Pub. Date: Apr. 24, 2008

(54) Light source control unit and light source control method

(75) Inventor: Naotaka Ebe, Kumagaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/802,677

(22) Filed: May 24, 2007

(30) Foreign Application Priority Data
Oct. 18, 2006 (JP) 2006-284259

(51) Int. Cl. G09G 5/10

(52) U.S. Cl. 345/690

(57) ABSTRACT

A light source control unit includes: a controlled variable calculation unit continuously calculating a controlled variable of a light source based on a luminance of an image represented by an image data; a limiting unit limiting a time variation of the calculated controlled variable; and a control unit controlling the luminance of the light source based on the limited controlled variable.

### CROSS-REFERENCE TO RELATED APPLICATIONS

This application is based upon and claims the benefit of priority from the prior Japanese Patent Application No. 2006-284259, filed on Oct. 18, 2006; the entire contents of which are incorporated herein by reference.

### BACKGROUND OF THE INVENTION

1. Field of the Invention

The present invention relates to a light source control unit and a light source control method controlling a light source for a display device using a non-light-emitting display element.

2. Description of the Related Art

A light-emitting display device can be constituted by combining a non-light-emitting display element (for example, a liquid crystal display element or a digital micro-mirror device) and a light source (for example, a backlight). At this time, there is a case when light intensity of the light source is controlled based on an image signal which drives a display element. The light intensity of the light source is controlled in accordance with an image to be displayed, and thereby, a dynamic range of the display device can be enlarged. Incidentally, an art relating to a luminance adjusting unit including a backlight dimmer control and a limiter considering an average luminance and a gamma correction value of an input signal is laid-open (JP-A 2002-108305 (KOKAI)).

### SUMMARY OF THE INVENTION

In the above-stated art, it is not disclosed that a rapid variation of light intensity of a backlight is prevented. When the light intensity of the backlight is controlled by the image signal, there is a possibility that the light intensity of the backlight varies rapidly caused by a rapid change of an image represented by the image signal. The rapid variation of the light intensity as stated above may be a disturbance when the image is viewed. In consideration of the above, an object of the present invention is to provide a light source control unit and a light source control method in which a prevention of the rapid variation of the light intensity of a light source for a non-light-emitting display element is realized.

A light source control unit according to an aspect of the present invention, includes: a controlled variable calculation unit continuously calculating a controlled variable of a light source based on a luminance of an image represented by an image data; a limiting unit limiting a time variation of the calculated controlled variable; and a control unit controlling a luminance of the light source based on the limited controlled variable.

A light source control method according to an aspect of the present invention, includes: continuously calculating a controlled variable of a light source based on a luminance of an image represented by an image data; limiting a time variation of the calculated controlled variable; and controlling the luminance of the light source based on the limited controlled variable.

### BRIEF DESCRIPTION OF THE DRAWINGS

FIG. 1 is a block diagram showing a display system 100 according to an embodiment of the present invention.

FIG. 2 is a graphic chart showing an example of a histogram.

FIG. 3 is a graphic chart showing an example of a correspondence between an amount of dark histogram and a backlight controlled variable.

FIG. 4 is a graphic chart showing an example of a correspondence between a variation of the amount of dark histogram and a variation of the controlled variable.

FIG. 5 is a graphic chart showing an example of a temporal change of the controlled variable.

FIG. 6 is a flowchart showing an example of an operation procedure of the display system 100.

### DESCRIPTION OF THE EMBODIMENTS

Hereinafter, embodiments of the present invention are descried in detail with reference to the drawings.

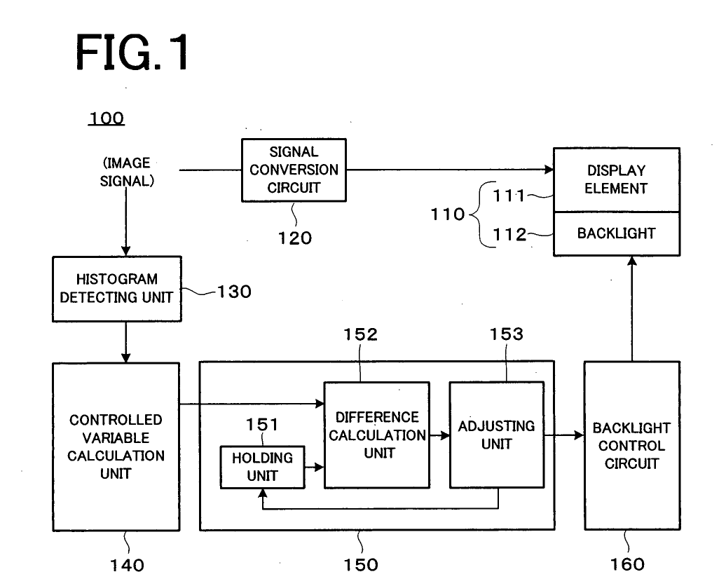

FIG. 1 is a block diagram showing a display system 100 according to an embodiment of the present invention. The display system 100 is a system in which an image is displayed based on an image signal (called also as a video signal), and it has a display device 110, a signal conversion circuit 120, a histogram detecting unit 130, a controlled variable calculation unit 140, a time variation limiting unit 150, and a backlight control circuit 160.

The display device 110 has a display element 111 and a backlight 112, and functions as a light-emitting display device as a whole. The display element 111 is a non-light-emitting display element, for example, a liquid crystal display element. Plural pixels are disposed on a display screen of the display element 111 in a matrix state. A transmission amount of light of each pixel is controlled, and thereby, an image is displayed. Incidentally, when the display element 111 contains the pixels of different display colors (for example, R (red), G (green), and B (blue)), a combination of pixels of adjacent display colors (for example, R, G, B) may be defined as one pixel. The back light 112 is a light source illuminating the display element 111 from behind.

The signal conversion circuit 120 is a circuit converting an inputted image signal into a drive signal of the display element 111. Image data corresponding to the display screen of the display element 111 are contained in the image signal in time-series. Pixel data corresponding to the pixels of the display element 111 are contained in the image data. The image data used for a control of the display element 111 are switched in time-series, and thereby, the image displayed on the display element 111 can be switched (display of a moving image).

The histogram detecting unit 130 detects a histogram (luminance distribution on the display screen of the display element 111), in particular, an amount of dark histogram from the image signal. The image signal contains the image data of one screen in time-series, and therefore, the detected amount of dark histograms are outputted sequentially.

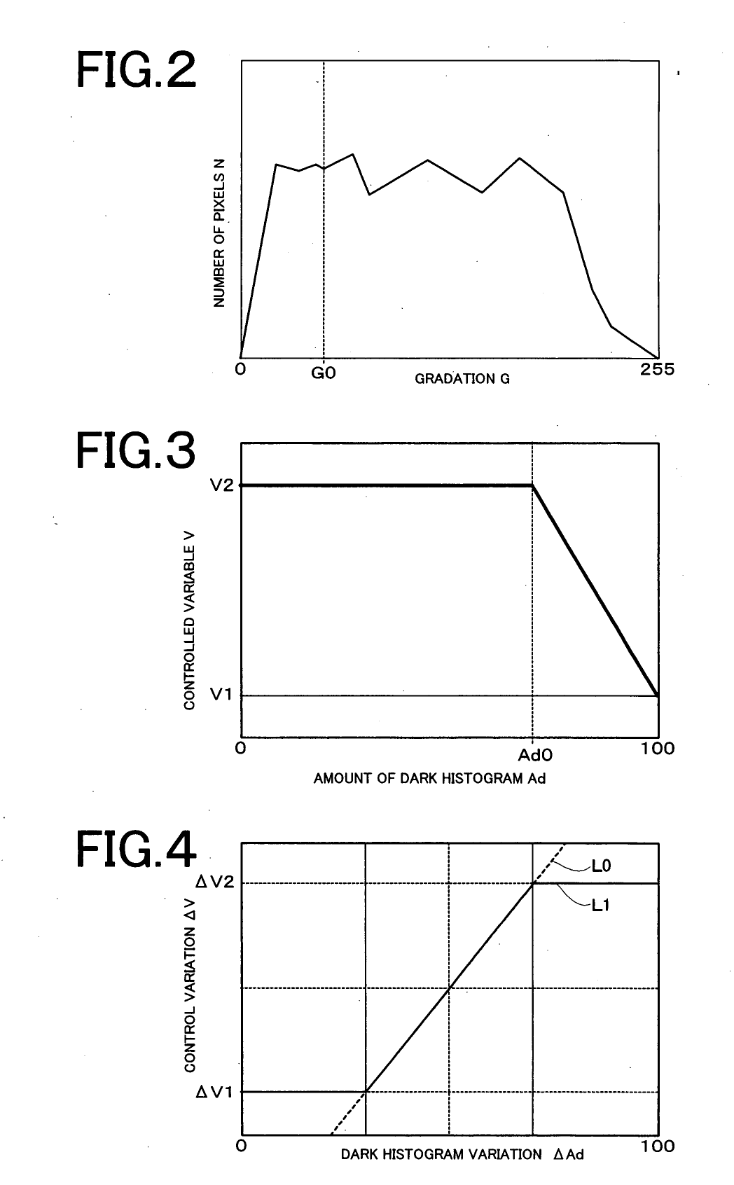

FIG. 2 is a graphic chart showing an example of the histogram. A horizontal axis and vertical axis of this graphic chart respectively show a gradation G and the number of pixels N. The gradation means the luminance of each pixel constituting the display screen of the display element 111. Here, the gradation is represented by eight bits of “0” (zero) to 255. The number of pixels means the number of pixels corresponding to the gradation.

An amount of dark histogram Ad means a rate of pixels having the gradation not more than a predetermined reference gradation G0 (for example, 50) as shown in the next expression (1). Incidentally, an amount corresponding to this rate, for example, the number N1 in itself may be defined as the amount of dark histogram Ad. It is possible to calculate a later-described controlled variable V by using the number N1 in itself.

Ad=N1/N0 expression (1)

N0: Total number of pixels

N1: The number of pixels not more than the reference gradation

The amount of dark histogram Ad is used as an index representing a degree of darkness of the image on the display screen. The light intensity of the backlight 112 is controlled in accordance with the degree of darkness (brightness) of the image, and thereby, it is possible to increase a contrast feeling of a dark image.

The controlled variable calculation unit 140 calculates the controlled variable V of the backlight 112 from the amount of dark histogram Ad detected by the histogram detecting unit 130. This controlled variable V is used for a control of the light intensity of the backlight 112 by the backlight control circuit 160. The controlled variable calculation unit 140 has a means to calculate the controlled variable V, for example, a table showing a correspondence between the amount of dark histogram Ad and the controlled variable V (refer to later-described FIG. 3).

It is difficult for the display element 111 to shut out the light completely, and even a pixel with low gradation transmits the light to some extent. Accordingly, when the luminance of the backlight 112 is constant, it becomes difficult to secure the contrast feeling in a dark image (scene).

On the contrary, the darkness of the image is discriminated based on the amount of dark histogram Ad, to lower the luminance of the backlight 112 in accordance with the darkness, and thereby, it becomes possible to improve the contrast feeling of the image. Namely, the light intensity of the backlight 112 is lowered when the amount of dark histogram Ad is large.

FIG. 3 is a graphic chart showing an example of the correspondence between the amount of dark histogram Ad and the controlled variable V of the backlight 112. A horizontal axis and vertical axis of the graphic chart respectively show the amount of dark histogram Ad and the controlled variable V. Here, the controlled variable is a constant value (V2) when the amount of dark histogram Ad is not more than a reference value Ad0. In a range when the amount of dark histogram Ad exceeds the reference value Ad0, the larger the amount of dark histogram Ad becomes, the more the controlled variable V deteriorates linearly. Namely, the backlight 112 is darkened in the dark image. As a result of this, it becomes possible to improve the contrast feeling in the dark image.

The time variation limiting unit 150 limits a time variation AV of the controlled variable V within a predetermined range. Namely, a rapid variation of the light intensity of the backlight 112 is limited even when the luminance of the image changes rapidly. For example, when the image changes rapidly (a scene when a bird claps its wings, and so on), or when a dark image and a bright image appear alternately, the luminance on the display image varies rapidly. In this case, the image becomes difficult to see if the light intensity of the backlight 112 changes following the above-stated variation.

The time variation limiting unit 150 has a holding unit 151, a difference calculation unit 152, and an adjusting unit 153.

The holding unit 151 holds a controlled variable V0 adjusted at the adjusting unit 153. This controlled variable V0 is used for the control of the backlight 112 at a previous screen.

The difference calculation unit 152 calculates a difference ΔV between the controlled variable V calculated at the controlled variable calculation unit 140 and the controlled variable V0 held by the holding unit 151 by the next expression (2). This difference ΔV means the difference between the controlled variable V at this time and the controlled variable V0 at the previous time, namely, a temporal variation (control variation) of the controlled variable V.

ΔV=V−V0 expression (2)

The adjusting unit 153 adjusts the controlled variable V and outputs the adjusted controlled variable V0. When the calculated difference ΔV exceeds a predetermined tolerance range (a lower limit value ΔV1 to an upper limit value ΔV2), the controlled variable V is adjusted, and the difference of the controlled variables between this time and the previous time is limited within the tolerance range. Namely, the adjusting unit 153 functions as a judging unit judging whether the difference ΔV exceeds the predetermined range or not, and as an adjusting unit adjusting the controlled variable V based on this judged result. Incidentally, the adjusting unit 153 also functions as a rewriting unit rewriting the held controlled variable into the adjusted controlled variable. Here, the upper and lower limits of the tolerance range can be prescribed by positive/negative values having equal absolute values (ΔV1=−C, ΔV2=+C).

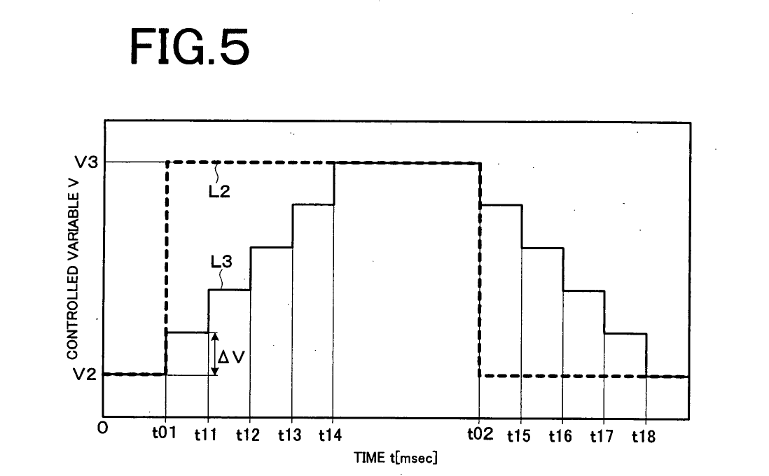

FIG. 4 is a graphic chart showing an example of a correspondence between the variation of the amount of dark histogram and the variation of the controlled variable at this time. A horizontal axis and vertical axis of the graphic chart respectively show a dark histogram variation ΔAd and the control variation ΔV. The dark histogram variation ΔAd means a difference of the amount of dark histogram Ad between screens of this time and the previous time. The control variation ΔV means a difference of the controlled variables V between the screens of this time and the previous time.

Graphs L0, L1 respectively show a correspondence between the dark histogram variation ΔAd and the control variation ΔV before and after the limitation by the time variation limiting unit 150. In the graph L1, the control variation (difference) ΔV is limited so as not to exceed the tolerance range.

FIG. 5 is a graphic chart showing an example of a temporal change of the controlled variable V. A horizontal axis, vertical axis of the graphic chart respectively show the time t and the controlled variable V. Graphs L2, L3 respectively show-temporal changes of the controlled variables V before and after the limitation by the time variation limiting unit 150.

At the time t01, the controlled variable outputted from the controlled variable calculation unit 140 increases rapidly from V2 to V3. The difference of the controlled variables exceeds the tolerance range, and therefore, the variation of the controlled variable V is limited from the time t01 to the time t14. Namely, the change of the controlled variable (difference of the controlled variables) ΔV compared to the previous time is adjusted to be within the tolerance range at the times t01, t11, t12, t13, and t14.

Similarly, at the time t02, the controlled variable outputted from the controlled variable calculation unit 140 decreases rapidly from V3 to V2. The difference of the controlled variables exceeds the tolerance range, and therefore, the variation of the controlled variable V is limited from the time t02 to the time t18. Namely, at the times t02, t15, t16, t17, and t18, the change of the controlled variable (difference of the controlled variables) ΔV compared to the previous time is adjusted to be within the tolerance range.

The backlight control circuit 160 is a control circuit controlling the luminous of the backlight 112 based on the controlled variable calculated by the controlled variable calculation unit 140 and the time variation thereof is limited by the time variation limiting unit 150. The backlight control circuit 160 functions as a control unit controlling the light intensity of the light source based on the limited controlled variable.

As stated above, it becomes possible to suppress the rapid variation of the luminous on the screen by controlling the temporal change (difference) of the controlled variable V so as not to exceed the tolerance range.

### (Operations of Display System 100)

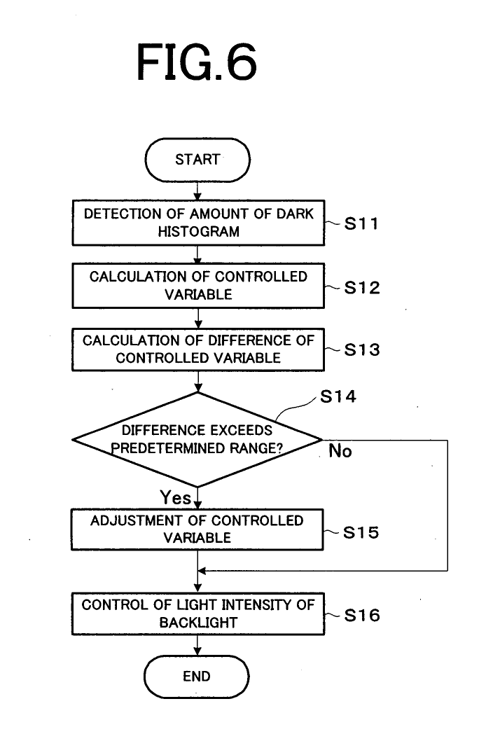

FIG. 6 is a flowchart showing an example of an operation procedure of the display system 100. The following steps S11 to S16 are executed repeatedly.

### (1) Detection of Dark Histogram Volume (Step S11)

The histogram detecting unit 130 detects the amount of dark histogram Ad from the image signal. Namely, the rate of the number of pixels having the gradation lower than the predetermined reference gradation G0 (or the number thereof in itself) is calculated. The luminance of the backlight 112 is controlled in accordance with the degree of darkness (brightness) of the image, and thereby, it becomes possible to increase the contrast feeling of the dark image. The image data is contains in the image signal in time-series, and therefore, the amount of dark histogram Ad is continuously detected.

### (2) Calculation of Control Amount V (Step S12)

The controlled variable calculation unit 140 calculates the controlled variable V from the amount of dark histogram. For example, the controlled variable V can be calculated by a table showing a correspondence of the above.

### (3) Calculation of Difference ΔV of Control Amount V (Step S13)

The difference calculation unit 152 calculates the difference ΔV of the controlled variable V (temporal variation of the controlled variable V). Namely, the difference ΔV between the controlled variable V calculated at the controlled variable calculation unit 140 and the controlled variable V0 held by the holding unit 151 is calculated.

### (4) Adjustment of Control Amount V (Steps S14, S15)

The adjusting unit 153 judges whether the difference ΔV of the controlled variable V exceeds the tolerance range or not (Step S14). When the difference ΔV exceeds the tolerance range, the adjusting unit 153 adjusts the controlled variable V (Step S15).

### (5) Control of Light Intensity of Backlight 112 (Step S16)

The backlight control circuit 160 controls the luminance of the backlight 112 based on the controlled variable calculated at the controlled variable calculation unit 140 and of which time variation is limited at the time variation limiting unit 150.

As stated above, a control signal (controlled variable) controlling the light intensity (luminance) of the backlight 112 is generated at the display system 100. This control signal changes in accordance with the luminance of the image represented by the image signal, and the time variation thereof is limited. As a result, compatibility between a response of the light intensity of the backlight 112 and the prevention of the rapid variation is realized. Namely, the backlight 112 is normally controlled with a good response, and it becomes possible to prevent an occurrence of a sense of incompatibility when the image changes rapidly (the scene when the bird claps its wings, and so on).

### Other Embodiments

Embodiments of the present invention can be expanded/modified without being limited to the above-described embodiments, and such expanded/modified embodiments are also included in the technical scope of the present invention. In the above-stated embodiment, the controlled variable of the backlight is calculated based on the amount of dark histogram. It is also possible to calculate the controlled variable of the backlight based on other amounts. For example, an average luminance (average picture level), amount of light histogram, minimum luminance, and maximum luminance. The light histogram volume means a rate of pixels having the gradation which is more than a predetermined reference gradation. The minimum luminance means the lowest luminance within the image. However, the luminance in which the number of pixels at the luminance is smaller than a predetermined value is excepted. The maximum luminance means the maximum luminance within the image. The luminance in which the number of pixels at the luminance is smaller than a predetermined value is excepted, as same as the minimum luminance.

What is claimed is:

1. A light source control unit, comprising:
a controlled variable calculation unit continuously calculating a controlled variable of light intensity of a light source based on a luminance of an image represented by an image data;
a limiting unit limiting a time variation of the calculated controlled variable; and
a control unit controlling the light intensity of the light source based on the limited controlled variable.

2. The light source control unit according to claim 1,
wherein the image data contains pixel data corresponding to pixels constituting the image, and
the controlled variable calculation unit calculates the controlled variable based on a rate of pixels having lower luminance than a predetermined luminance.

3. The light source control unit according to claim 1,
wherein the image data contains pixel data corresponding to pixels constituting the image, and
the controlled variable calculation unit calculates the controlled variable based on a rate of pixels having higher luminance than a predetermined luminance.

4. The light source control unit according to claim 1,
wherein the controlled variable calculation unit calculates the controlled variable based on an average luminance of the image.

5. The light source control unit according to claim 1,
wherein the limiting unit includes:
a holding unit holding the controlled variable;
a difference calculation unit calculating a difference between the held controlled variable and the calculated controlled variable;
a judging unit judging whether the calculated difference exceeds a predetermined range or not;
an adjusting unit adjusting the calculated controlled variable based on the judged result; and
a rewriting unit rewriting the held controlled variable into the adjusted controlled variable.

6. The light source control unit according to claims 1, further comprising:
a display unit displaying the image.

7. A light source control method, comprising:
continuously calculating a controlled variable of light intensity of a light source based on a luminance of an image represented by an image data;
limiting a time variation of the calculated controlled variable; and
controlling the light intensity of the light source based on the limited controlled variable.

8. The light source control method according to claim 7,
wherein the image data contains pixel data corresponding to pixels constituting the image, and
the controlled variable is calculated based on a rate of pixels with lower luminance than a predetermined luminance in the step of calculating the controlled variable.

9. The light source control method according to claim 7,
wherein the image data contains pixel data corresponding to pixels constituting the image; and
the controlled variable is calculated based on a rate of pixels with higher luminance than a predetermined luminance in the step of calculating the controlled variable.

10. The light source control method according to claim 7,
wherein the controlled variable is calculated based on an average luminance of the image in the step of calculating the controlled variable.

11. The light source control method according to claim 7,
wherein the step of limiting includes:
calculating a difference between a held controlled variable and the calculated controlled variable;
judging whether the calculated difference exceeds a predetermined range or not;
adjusting the calculated controlled variable based on the judged result; and
rewriting the held controlled variable into the adjusted controlled variable.
